(19) United States
(12) Patent Application Publication
(10) Pub. No.: US 2026/0317508 A1
(43) Pub. Date: Oct. 15, 2026

(54) CONDUCTIVE RUBBER COMPOSITE MATERIAL, PREPARATION METHOD THEREOF, AND APPLICATION THEREOF

(71) Applicant: Guangzhou Power Supply Bureau of Guangdong Power Grid Co., Ltd., Guangzhou (CN)

(72) Inventors: Hanru LI, Guangzhou (CN); Jiasheng HUANG, Guangzhou (CN); Zhuozhan HAN, Guangzhou (CN); Yuan LIU, Guangzhou (CN); Meng LI, Guangzhou (CN); Qian RAN, Guangzhou (CN); Tao ZHANG, Guangzhou (CN); Fei ZHANG, Guangzhou (CN)

(73) Assignee: Guangzhou Power Supply Bureau of Guangdong Power Grid Co., Ltd., Guangzhou (CN)

(21) Appl. No.: 19/333,927

(22) Filed: Sep. 19, 2025

(30) Foreign Application Priority Data
Apr. 14, 2025 (CN) 202510460480.8

(51) Int. Cl. C08K 3/04; C08J 7/04; C08J 7/044; C08K 7/24

(52) U.S. Cl. CPC C08K 3/041; C08J 7/0427; C08J 7/044; C08K 7/24; C08J 2309/00; C08J 2333/02; C08K 2201/001; C08K 2201/005; C08K 2201/014

(57) ABSTRACT

A conductive rubber composite material, a preparation method thereof, and an application thereof. The conductive rubber composite material includes a conductive rubber substrate and a conductive layer coated on a surface of the conductive rubber substrate. The conductive rubber substrate includes following raw materials in parts by mass: 100 parts of a rubber material and 20 to 30 parts of first carbon black, wherein an average particle size of the first carbon black is in a range from 30 nm to 150 nm. The conductive layer includes following raw materials in parts by mass: 100 parts of a coating base material, 8 to 15 parts of second carbon black, and 1 to 5 parts of carbon nanotubes, wherein an average particle size of the first carbon black is 1.2 to 8 times the average particle size of the second carbon black. A thickness of the conductive layer is in a range from 0.05 mm to 0.2 mm.

### RELATED APPLICATIONS

This application claims priority to Chinese patent application No. 202510460480.8, entitled “CONDUCTIVE RUBBER COMPOSITE MATERIAL, PREPARATION METHOD THEREOF, AND APPLICATION THEREOF” filed on Apr. 14, 2025, the content of which is hereby incorporated by reference in its entirety.

### TECHNICAL FIELD

The present application relates to the technical field of composite materials, specifically to a conductive rubber composite material, a preparation method thereof, and an application thereof.

### BACKGROUND

One of the primary characteristics of rubber materials is their high electrical resistivity, making them excellent insulating materials. Additionally, rubber possesses good toughness and corrosion resistance, leading to wide applications in various electrically insulating products. However, in critical technical fields such as sealing and electromagnetic shielding, there is a need for rubber to exhibit both excellent mechanical performance and enhanced electrical conductivity to meet technical requirements, resulting in the development of conductive rubber. A typical method for preparing conductive rubber involves dispersing electrically conductive fillers in the insulating rubber, where the electrically conductive fillers form electrically conductive pathways to impart electrical conductivity to the rubber. However, the incorporation of electrically conductive fillers significantly reduces the mechanical performance of the rubber. Therefore, achieving a conductive rubber with high electrical conductivity while maintaining the mechanical performance such as high flexibility and high elasticity has become an urgent challenge to address.

### SUMMARY

To address the issues of the prior art, the present application provides a conductive rubber composite material. By coating a conductive layer containing carbon black and carbon nanotubes onto the surface of a conductive rubber substrate containing carbon black as an electrically conductive filler, the electrical conductivity of the rubber substrate can be enhanced while the mechanical performance of the rubber substrate can be maintained.

Another object of the present application is to provide a method for preparing the conductive rubber composite material.

Another object of the present application is to provide an application of the conductive rubber composite material.

The above objects of the present application are achieved through the following technical solutions:
A conductive rubber composite material includes a conductive rubber substrate and a conductive layer coated on a surface of the conductive rubber substrate;
the conductive rubber substrate includes following raw materials in parts by mass: 100 parts of a rubber material and 20 to 30 parts of first carbon black, wherein an average particle size of the first carbon black is in a range from 30 nanometers (nm) to 150 nm;
the conductive layer includes following raw materials in parts by mass: 100 parts of a coating base material, 8 to 15 parts of second carbon black, and 1 to 5 parts of carbon nanotubes, wherein an average particle size of the first carbon black is 1.2 to 8 times the average particle size of the second carbon black; and
a thickness of the conductive layer is in a range from 0.05 millimeters (mm) to 0.2 mm.

The conventional conductive rubber is typically prepared by incorporating a conductive filler in rubber. To enhance the electrical conductivity of conductive rubber, related methods often involve increasing the amount of conductive filler added in the rubber. However, increasing the filler content leads to a decline in the mechanical performance of the conductive rubber due to the aggregation of the excessive conductive filler. The aggregated conductive rubber acts as stress concentration points when the rubber is subjected to external forces, triggering rubber fracture, and reducing the tensile strength and toughness of the rubber. Additionally, the increased filler content may hinder the movement of molecular chains within the rubber substrate, making the rubber material harder and more brittle. In the present application, the conductive rubber composite material includes a conductive rubber substrate and a conductive layer coated on a surface of the conductive rubber substrate, which are prepared from the above-described raw materials. Through extensive experimental research, the inventors of the present application have found that the electrical conductivity of the conductive rubber composite material can be significantly enhanced by introducing a small amount, e.g., 20 wt % to 30 wt %, of carbon black as a conductive filler into the rubber material to maintain the mechanical performance of the conductive rubber substrate, and applying a conductive layer containing carbon black and carbon nanotubes onto the surface of the conductive rubber substrate. The carbon nanotubes have a one-dimensional linear morphology, which can synergistically interact with the spherical carbon black filler in the conductive layer and can synergistically composite with the carbon black in the conductive rubber substrate, forming abundant electrically conductive pathways within the conductive layer and between the conductive layer and the conductive rubber substrate.

It should be noted that the particle sizes of the first carbon black in the conductive rubber substrate and the second carbon black in the conductive layer formed by coating on the surface of the conductive rubber substrate are different, and both need to be controlled within specific ranges. The average particle size of the first carbon black in the conductive rubber substrate is in a range from 30 nm to 150 nm, and is 1.2 to 8 times the average particle size of the second carbon black in the conductive layer. That is, the average particle size of the second carbon black is in a range from 3.75 nm to 125 nm, while the particle size of the second carbon black is smaller than that of the first carbon black. This specific range combination is necessary because if the particle size of the first carbon black in the conductive rubber substrate is too small, the contribution provided by the first carbon black to enhancing the mechanical performance of the conductive rubber substrate is insufficient. However, if the particle size of the first carbon black is too large, the interaction between the conductive rubber substrate and the conductive layer decreases. Through extensive experiments and studies, the inventors of the present application have discovered that when the average particle size of the first carbon black in the conductive rubber substrate is 1.2 to 8 times that of the second carbon black in the conductive layer, and carbon nanotubes are added to composite with the second carbon black in the conductive layer, the conductive layer can form a strong adhesion and bonding with the substrate. This is because carbon black with smaller particle size exhibits stronger surface activity and van der Waals forces, while carbon black with larger particle size experiences reduced van der Waals interactions between its particles. By respectively adopting the first carbon black and the second carbon black, where the average particle size of the first carbon black is 1.2 to 8 times that of the second carbon black, along with carbon nanotubes, as the fillers in the conductive rubber substrate and the conductive layer, robust bonding can be formed between the conductive rubber substrate and the conductive layer through van der Waals forces between fillers of different particle sizes and morphologies. The robust bonding between the conductive layer and the conductive rubber substrate ensures that the conductive rubber composite material exhibits excellent electrical conductivity without introducing stress concentration points, thereby also possessing superior mechanical performance.

Changing the spherical filler in the conductive layer or the conductive rubber substrate from carbon black to other types of fillers would result in a reduction of van der Waals forces between the fillers in the conductive layer and the conductive rubber substrate, leading to decreased interfacial bonding strength between the conductive layer and the substrate and consequently reducing the electrical conductivity and mechanical performance of the composite material. Similarly, replacing the carbon nanotubes in the conductive layer with other linear one-dimensional fillers, or simultaneously replacing both the carbon black and carbon nanotubes with combinations of other zero-dimensional and one-dimensional materials, would also lead to a decline in the performance of the resulting conductive rubber composite material. A hypothesized cause is the higher compatibility between carbon nanotubes and carbon black.

It should be noted that an insufficient total amount of conductive fillers (including carbon nanotubes and the second carbon black) in the conductive layer would impair the electrical conductivity of the resulting composite material. Conversely, an excessive total amount of conductive fillers leads to aggregation, which reduces the bonding strength between the conductive layer and the conductive rubber substrate. The proportion of carbon nanotubes in the conductive fillers also affects the interaction between the conductive layer and the conductive rubber substrate. If the proportion of carbon nanotubes added is too low, the connecting effect provided by the carbon nanotubes on the second carbon black in the conductive layer and the first carbon black in the conductive rubber substrate is insufficient, resulting in an inadequate number of conductive pathways. However, if the proportion of carbon nanotubes is too high, their high surface activity makes them prone to aggregation, which also leads to a decline in electrical conductivity.

The thickness of the conductive layer also affects the performance of the resulting composite material. If the conductive layer is too thin, the conductive fillers cannot fully exert their effects. However, if the conductive layer is too thick, the second carbon black and carbon nanotubes in the conductive layer, particularly those farther from the conductive rubber substrate, can hardly interact molecularly with the first carbon black in the conductive rubber substrate. This not only hinders the formation of conductive pathways, leading to reduced electrical conductivity, but also causes the conductive layer to be prone to detachment under external forces, thereby adversely affecting the mechanical performance of the resulting composite material.

Optionally, the average particle size of the first carbon black is 2 to 4 times the average particle size of the second carbon black.

Optionally, the average particle size of the first carbon black in the conductive rubber substrate is in a range from 60 nm to 100 nm.

Optionally, the carbon nanotubes in the conductive layer have a length in a range from 5 nm to 50 nm and a length-to-diameter ratio in a range from 100 to 1000.

Further optionally, the average particle size of the second carbon black in the conductive layer is in a range from 20 nm to 50 nm.

Optionally, a mass ratio of the second carbon black to the first carbon black is in a range from 1:2 to 1:4.

Optionally, the conductive rubber substrate further includes at least one of an anti-aging agent, a vulcanization accelerator, or a vulcanizing agent.

Further optionally, the rubber material includes butyl rubber.

Further optionally, the anti-aging agent includes N-cyclohexyl-N′-phenyl-p-phenylenediamine (i.e., anti-aging agent 4010), paraffin, or a combination of N-cyclohexyl-N′-phenyl-p-phenylenediamine and paraffin.

Further optionally, in the raw materials of the conductive rubber substrate, the anti-aging agent is in an amount of 5 to 10 parts by mass.

Further optionally, a mass ratio of N-cyclohexyl-N′-phenyl-p-phenylenediamine to paraffin in the anti-aging agent is (2 to 4):(4 to 8).

Further optionally, the vulcanization accelerator includes stearic acid, zinc oxide, or a combination of stearic acid and zinc oxide.

Further optionally, in the raw materials of the conductive rubber substrate, the vulcanization accelerator is in an amount of 5 to 8 parts by mass.

Further optionally, a mass ratio of stearic acid to zinc oxide in the vulcanization accelerator is (1 to 2):(5 to 7).

In embodiments of the present application, the vulcanizing agent in the raw materials for preparing the conductive rubber substrate can be any conventional vulcanizing agent, such as sulfur and 1,4-benzoquinone dioxime.

Optionally, in the raw materials of the conductive rubber substrate, the vulcanizing agent is in an amount of 1 to 3 parts by mass.

Optionally, the conductive layer further includes a dispersant.

Further optionally, the dispersant includes a non-ionic surfactant.

Further optionally, in the raw materials of the conductive layer, the dispersant is in an amount of 1 to 2 parts by mass.

Further optionally, the non-ionic surfactant includes fatty alcohol polyoxyethylene ether. Optionally, a thickness of the conductive layer is in range from 0.8 mm to 1.2 mm.

Optionally, the coating base material includes acrylic acid emulsion or acrylic acid.

Optionally, the acrylic acid emulsion includes acrylic acid and a solvent, wherein a mass ratio of the acrylic acid to the solvent is 1:3. Correspondingly, the conductive layer includes following raw materials in parts by mass: 70 parts of a coating base material, 8 to 15 parts of second carbon black, and 1 to 5 parts of carbon nanotubes, wherein the average particle size of the first carbon black is 1.2 to 8 times an average particle size of the second carbon black; and a thickness of the conductive layer is in a range from 0.05 mm to 0.2 mm.

The present application further provides a method for preparing the conductive rubber composite material, including following steps:
S1, uniformly mixing the raw materials of the conductive rubber substrate in parts by mass, kneading and vulcanizing at a temperature of 60° C. to 100° C., and molding at a temperature of 150° C. to 200° C. under a pressure of 10 MPa to 20 MPa to obtain the conductive rubber substrate; and
S2, uniformly mixing the raw materials of the conductive layer in parts by mass to obtain a conductive layer slurry, coating the conductive layer slurry onto a surface of the conductive rubber substrate obtained in step S1, and drying, thereby achieving the conductive rubber composite material.

In a specific embodiment, in step S1, a kneading time is about 10 minutes (min).

In a specific embodiment, in step S1, a vulcanizing time is about 15 min.

In a specific embodiment, in step S1, a molding time is about 5 min.

In a specific embodiment, after molding, step S1 further includes steps of cooling and drying. Specifically, the cooling is air cooling, and a cooling time is about 5 min. Specifically, drying is performed at 40° C., and a drying time is about 24 hours (h).

In a specific embodiment, a thickness of the conductive rubber substrate obtained in step S1 is about 1 mm.

In a specific embodiment, after uniformly mixing the raw materials, step S2 further includes steps of standing and degassing. Specifically, the standing is performed for 15 min.

In a specific embodiment, in step S2, a coating speed is in a range from 3 millimeters per second (mm/s) to 10 mm/s.

The present application further provides an application of the above-described conductive rubber composite material in the fields of sealing materials and electromagnetic shielding materials.

Compared with the prior art, the embodiments of the present application have the following beneficial effects:

In the conductive rubber composite material provided in embodiments of the present application, a conductive layer containing carbon black and carbon nanotubes is coated onto the surface of a conductive rubber substrate containing carbon black as an electrically conductive filler, wherein the carbon black in the conductive rubber substrate and the carbon black in the conductive layer have different particle sizes, enabling stable bonding between the conductive layer and the substrate through van der Waals interactions. The one-dimensional linear morphology of carbon nanotubes allows them to synergistically interact with the spherical carbon black fillers in both the conductive layer and the conductive rubber substrate, forming abundant electrically conductive pathways. This not only enhances the electrical conductivity of the resulting composite material but also avoids introducing stress concentration points within the composite material. Consequently, the conductive rubber composite material provided by the present application achieves both improved mechanical performance and enhanced electrical conductivity, with a volume resistivity equal to or less than 42 Ω·cm and an elongation at break equal to or greater than 620%, which exhibit excellent comprehensive performance, indicating broad application prospects in the fields of sealing materials and electromagnetic shielding materials.

### BRIEF DESCRIPTION OF THE DRAWING

FIG. 1 shows a scanning electron microscopy (SEM) image of a conductive rubber composite material obtained in Example 1 of the present application.

### DETAILED DESCRIPTION

The present application will be further described below with reference to specific examples. However, these examples do not limit the present application in any way. Unless otherwise specified, the raw materials and reagents used in the examples of the present application are conventionally commercially available raw materials and reagents. The information of the raw materials used in each example and comparative example is as follows:

Butyl rubber was purchased from JSR Corporation, Japan, with the product model of 268.

First carbon black A was purchased from Jiangxi Black Cat Carbon Black Inc Ltd., with the product model of M3710 and an average particle size of about 75 nm.

First carbon black B was purchased from Jiangxi Black Cat Carbon Black Inc Ltd., with the product model of N774 and an average particle size of about 100 nm.

First carbon black C was purchased from ShanDong Link Technology Co., Ltd., with the product model of LK400 and an average particle size of about 20 nm.

First carbon black D was purchased from ShanDong Link Technology Co., Ltd., with the product model of LK2105 and an average particle size of about 200 nm.

Second carbon black A was purchased from Cabot Corporation, with the product model of VXC500 and an average particle size of about 30 nm.

Second carbon black B was purchased from Cabot Corporation, with the product model of M1300 and an average particle size of about 10 nm.

First carbon nanotubes were purchased from Siping Gaosida Nano Material Equipment Co., Ltd., with a length of about 25 nm and a length-to-diameter ratio of about 500.

Second carbon nanotubes were purchased from Siping Gaosida Nano Material Equipment Co., Ltd., with a length of about 50 nm and a length-to-diameter ratio of about 500.

Acrylic acid emulsion was purchased from Jinan Xinhanbang Chemical Technology Co., Ltd. The mass ratio of acrylic acid to the solvent in the acrylic acid emulsion is 1:3.

Fatty alcohol polyoxyethylene ether was purchased from Guangzhou Nanjia Chemical Technology Co., Ltd., with the product model of AEO7.

First activated carbon was purchased from Fujian Yuanli Active Carbon Co., Ltd., with the product model of YL-N75 and an average particle size of about 75 nm.

Second activated carbon was purchased from Fujian Yuanli Active Carbon Co., Ltd., with the product model of YL-N30 and an average particle size of about 30 nm.

Carbon nanofibers were purchased from Hangzhou Gaoke Composite Materials Co., Ltd., with a length of about 25 nm.

### Example 1

A conductive rubber composite material included a conductive rubber substrate and a conductive layer coated on the surface of the conductive rubber substrate.

The conductive rubber substrate included the following raw materials in parts by mass: 100 parts of butyl rubber, 30 parts of first carbon black A, 5 parts of zinc oxide, 2 parts of stearic acid, 2 parts of 1,4-benzoquinone dioxime, 2 parts of N-cyclohexyl-N′-phenyl-p-phenylenediamine, and 6 parts of paraffin.

The conductive layer included the following raw materials in parts by mass: 100 parts of acrylic acid emulsion, 10 parts of second carbon black A, 1 part of first carbon nanotubes, and 1 part of fatty alcohol polyoxyethylene ether.

The thickness of the conductive layer was 0.1 mm.

The preparation method of the conductive rubber composite material provided in this example included the following steps:
S1, the raw materials of the conductive rubber substrate in parts by mass were mixed uniformly. The mixture was kneaded at 70° C. for 10 min, and vulcanized in a flat-plate vulcanizer at 70° C. for 15 min, then molded at 170° C. under 15 MPa for 5 min, subsequently cooled for 5 min, and dried at 40° C. for 24 hours to obtain the conductive rubber substrate with a thickness of 1 mm.
S2, the raw materials of the conductive layer in parts by mass were mixed uniformly, stood for 15 min and degassed, obtaining a conductive layer slurry. The conductive layer slurry was applied onto the surface of the conductive rubber substrate obtained in step S1 at a speed of 5 mm/s, and dried at 50° C. for 12 hours to obtain the conductive rubber composite material.

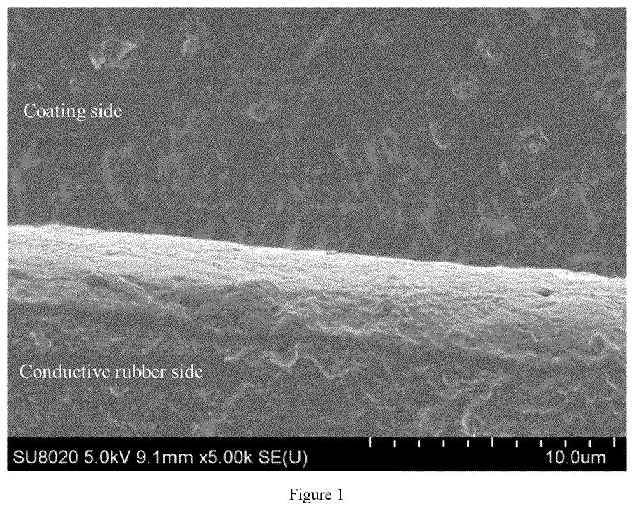

The SEM image of the conductive rubber composite material obtained in this example is shown in FIG. 1. Referring to FIG. 1, the conductive rubber composite material provided by the present application exhibits good bonding between the conductive layer and the conductive rubber substrate.

### Example 2

A conductive rubber composite material was provided, which was different from the conductive rubber composite material in Example 1 only in the following:

In the conductive layer, the second carbon black A was in an amount of 10 parts by mass, and the first carbon nanotubes were in an amount of 2 parts by mass.

The preparation method of the conductive rubber composite material in this example was consistent with that of Example 1.

### Example 3

A conductive rubber composite material was provided, which was different from the conductive rubber composite material in Example 1 only in the following:

In the conductive layer, the second carbon black A was in an amount of 10 parts by mass, and the first carbon nanotubes were in an amount of 3 parts by mass.

The preparation method of the conductive rubber composite material in this example was consistent with that of Example 1.

### Example 4

A conductive rubber composite material was provided, which was different from the conductive rubber composite material in Example 1 only in the following:

In the conductive rubber substrate, the first carbon black A was replaced with first carbon black B in equal parts by mass.

The preparation method of the conductive rubber composite material in this example was consistent with that of Example 1.

### Example 5

A conductive rubber composite material was provided, which was different from the conductive rubber composite material in Example 1 only in the following:

In the conductive layer, the second carbon black A was replaced with second carbon black B in equal parts by mass.

The preparation method of the conductive rubber composite material in this example was consistent with that of Example 1.

### Example 6

A conductive rubber composite material was provided, which was different from the conductive rubber composite material in Example 1 only in the following:

In the conductive layer, the first carbon nanotubes were replaced with second carbon nanotubes in equal parts by mass.

The preparation method of the conductive rubber composite material in this example was consistent with that of Example 1.

### Example 7

A conductive rubber composite material was provided, which was different from the conductive rubber composite material in Example 1 only in the following:

The raw materials of the conductive rubber substrate did not include N-cyclohexyl-N′-phenyl-p-phenylenediamine, and paraffin was in an amount of 8 parts by mass.

The preparation method of the conductive rubber composite material in this example was consistent with that of Example 1.

### Example 8

A conductive rubber composite material was provided, which was different from the conductive rubber composite material in Example 1 only in the following:

The raw materials of the conductive rubber substrate did not include zinc oxide, and stearic acid was in an amount of 7 parts by mass.

The preparation method of the conductive rubber composite material in this example was consistent with that of Example 1.

### Example 9

A conductive rubber composite material was provided, which was different from the conductive rubber composite material in Example 1 only in the following:

The thickness of the conductive layer was 0.05 mm.

The preparation method of the conductive rubber composite material in this example was consistent with that of Example 1.

### Example 10

A conductive rubber composite material was provided, which was different from the conductive rubber composite material in Example 1 only in the following:

The thickness of the conductive layer was 0.2 mm.

The preparation method of the conductive rubber composite material in this example was consistent with that of Example 1.

### Comparative Example 1

A conductive rubber composite material was provided, which was different from the conductive rubber composite material in Example 1 only in the following:

The conductive rubber composite material did not include the conductive layer, and in the conductive rubber substrate, the first carbon black A was in an amount of 20 parts by mass.

The preparation method of the conductive rubber composite material in this example was different from that in Example 1 only in the following:

The preparation method in this example did not include step S2.

### Comparative Example 2

A conductive rubber composite material was provided, which was different from the conductive rubber composite material in Example 1 only in the following:

The conductive rubber composite material did not include the conductive layer, and in the conductive rubber substrate, the first carbon black A was in an amount of 30 parts by mass.

The preparation method of the conductive rubber composite material in this example was different from that in Example 1 only in the following:

The preparation method in this example did not include step S2.

### Comparative Example 3

A conductive rubber composite material was provided, which was different from the conductive rubber composite material in Example 1 only in the following:

The conductive rubber composite material did not include the conductive layer, and in the conductive rubber substrate, the first carbon black A was in an amount of 40 parts by mass.

The preparation method of the conductive rubber composite material in this example was different from that in Example 1 only in the following:

The preparation method in this example did not include step S2.

### Comparative Example 4

A conductive rubber composite material was provided, which was different from the conductive rubber composite material in Example 1 only in the following:

In the conductive rubber substrate, the first carbon black A was in an amount of 20 parts by mass.

The conductive layer did not include carbon nanotubes, and the second carbon black A was in an amount of 10 parts by mass.

The preparation method of the conductive rubber composite material in this example was consistent with that of Example 1.

### Comparative Example 5

A conductive rubber composite material was provided, which was different from the conductive rubber composite material in Example 1 only in the following:

In the conductive rubber substrate, the first carbon black A was in an amount of 20 parts by mass.

The conductive layer did not include carbon nanotubes, and the second carbon black A was in an amount of 15 parts by mass.

The preparation method of the conductive rubber composite material in this example was consistent with that of Example 1.

### Comparative Example 6

A conductive rubber composite material was provided, which was different from the conductive rubber composite material in Example 1 only in the following:

The conductive layer did not include carbon nanotubes, and the second carbon black A was in an amount of 10 parts by mass.

The preparation method of the conductive rubber composite material in this example was consistent with that of Example 1.

### Comparative Example 7

A conductive rubber composite material was provided, which was different from the conductive rubber composite material in Example 1 only in the following:

The conductive layer did not include carbon nanotubes, and the second carbon black A was in an amount of 15 parts by mass.

The preparation method of the conductive rubber composite material in this example was consistent with that of Example 1.

### Comparative Example 8

A conductive rubber composite material was provided, which was different from the conductive rubber composite material in Example 1 only in the following:

In the conductive rubber substrate, 10 parts by mass of the first carbon black A were replaced with 10 parts by mass of first activated carbon.

The preparation method of the conductive rubber composite material in this example was consistent with that of Example 1.

### Comparative Example 9

A conductive rubber composite material was provided, which was different from the conductive rubber composite material in Example 1 only in the following:

In the conductive layer, 10 parts by mass of the second carbon black A were replaced with 10 parts by mass of second activated carbon.

The preparation method of the conductive rubber composite material in this example was consistent with that of Example 1.

### Comparative Example 10

A conductive rubber composite material was provided, which was different from the conductive rubber composite material in Example 1 only in the following:

In the conductive rubber substrate, the first carbon black A was replaced with first activated carbon in equal parts by mass.

In the conductive layer, the second carbon black A was replaced with second activated carbon in equal parts by mass, and the first carbon nanotubes were replaced with carbon nanofibers in equal parts by mass.

The preparation method of the conductive rubber composite material in this example was consistent with that of Example 1.

### Comparative Example 11

A conductive rubber composite material was provided, which was different from the conductive rubber composite material in Example 1 only in the following:

In the conductive layer, the first carbon nanotubes were replaced with carbon nanofibers in equal parts by mass.

The preparation method of the conductive rubber composite material in this example was consistent with that of Example 1.

### Comparative Example 12

A conductive rubber composite material was provided, which was different from the conductive rubber composite material in Example 1 only in the following:

In the conductive rubber substrate, the first carbon black A was in an amount of 40 parts by mass.

The preparation method of the conductive rubber composite material in this example was consistent with that of Example 1.

### Comparative Example 13

A conductive rubber composite material was provided, which was different from the conductive rubber composite material in Example 1 only in the following:

In the conductive layer, the second carbon black A was in an amount of 19 parts by mass, and the first carbon nanotubes were in an amount of 1 part by mass.

The preparation method of the conductive rubber composite material in this example was consistent with that of Example 1.

### Comparative Example 14

A conductive rubber composite material was provided, which was different from the conductive rubber composite material in Example 1 only in the following:

In the conductive layer, the second carbon black A was in an amount of 12 parts by mass, and the first carbon nanotubes were in an amount of 8 parts by mass.

The preparation method of the conductive rubber composite material in this example was consistent with that of Example 1.

### Comparative Example 15

A conductive rubber composite material was provided, which was different from the conductive rubber composite material in Example 1 only in the following:

In the conductive layer, the second carbon black A was in an amount of 20 parts by mass, and the first carbon nanotubes were in an amount of 4 parts by mass.

The preparation method of the conductive rubber composite material in this example was consistent with that of Example 1.

### Comparative Example 16

A conductive rubber composite material was provided, which was different from the conductive rubber composite material in Example 1 only in the following:

The thickness of the conductive layer was 0.5 mm.

The preparation method of the conductive rubber composite material in this example was consistent with that of Example 1.

### Comparative Example 17

A conductive rubber composite material was provided, which was different from the conductive rubber composite material in Example 1 only in the following:

In the conductive rubber substrate, the first carbon black A was replaced with first carbon black B in equal parts by mass. In the conductive layer, the second carbon black A was replaced with second carbon black B in equal parts by mass. The average particle size of the first carbon black A was 10 times the average particle size of the second carbon black B.

The preparation method of the conductive rubber composite material in this example was consistent with that of Example 1.

### Comparative Example 18

A conductive rubber composite material was provided, which was different from the conductive rubber composite material in Example 1 only in the following:

In the conductive rubber substrate, the first carbon black A was replaced with second carbon black A in equal parts by mass, meaning that the average particle size of the carbon black in the conductive rubber substrate was 1 time the average particle size of the carbon black in the conductive layer.

The preparation method of the conductive rubber composite material in this example was consistent with that of Example 1.

### Comparative Example 19

A conductive rubber composite material was provided, which was different from the conductive rubber composite material in Example 1 only in the following:

In the conductive rubber substrate, the first carbon black A was replaced with first carbon black D in equal parts by mass. The average particle size of the first carbon black D in the conductive rubber substrate was 6.7 times the average particle size of the second carbon black A in the conductive layer.

The preparation method of the conductive rubber composite material in this example was consistent with that of Example 1.

### Comparative Example 20

A conductive rubber composite material was provided, which was different from the conductive rubber composite material in Example 1 only in the following:

In the conductive rubber substrate, the first carbon black A was replaced with first carbon black C in equal parts by mass. In the conductive layer, the second carbon black A was replaced with second carbon black B in equal parts by mass. The average particle size of the first carbon black C was 2 times the average particle size of the second carbon black B in the conductive layer.

The preparation method of the conductive rubber composite material in this example was consistent with that of Example 1.

The conductive fillers and the particle size ratios of the zero-dimensional conductive fillers (such as, the carbon black, or the activated carbon) in the above-mentioned examples and comparative examples are shown in Table 1.

TABLE 1
Conductive fillers and particle size ratios of zero-dimensional
conductive fillers in examples and comparative examples

| | | | | | Particle size ratio of zero- |
|---|---|---|---|---|---|
| | Conductive filler in | | | | dimensional conductive |
| | conductive rubber | | Conductive filler in | | filler in conductive |
| | substrate | | conductive layer | | rubber substrate to that in |
| Group | Type | Parts | Type | Parts | conductive layer |
| Example 1 | first carbon | 30 | second carbon | 10 | 2.5:1 |
| | black A | | black A | | |
| | | | first carbon | 1 | |
| | | | nanotubes | | |
| Example 2 | first carbon | 30 | second carbon | 10 | 2.5:1 |
| | black A | | black A | | |
| | | | first carbon | 2 | |
| | | | nanotubes | | |
| Example 3 | first carbon | 30 | second carbon | 10 | 2.5:1 |
| | black A | | black A | | |
| | | | first carbon | 3 | |
| | | | nanotubes | | |
| Example 4 | first carbon | 30 | second carbon | 10 | 3.33:1 |
| | black B | | black A | | |
| | | | first carbon | 1 | |
| | | | nanotubes | | |
| Example 5 | first carbon | 30 | second carbon | 10 | 7.5:1 |
| | black A | | black B | | |
| | | | first carbon | 1 | |
| | | | nanotubes | | |
| Example 6 | first carbon | 30 | second carbon | 10 | 2.5:1 |
| | black A | | black A | | |
| | | | second carbon | 1 | |
| | | | nanotubes | | |
| Example 7 | first carbon | 30 | second carbon | 10 | 2.5:1 |
| | black A | | black A | | |
| | | | first carbon | 1 | |
| | | | nanotubes | | |
| Example 8 | first carbon | 30 | second carbon | 10 | 2.5:1 |
| | black A | | black A | | |
| | | | first carbon | 1 | |
| | | | nanotubes | | |
| Example 9 | first carbon | 30 | second carbon | 10 | 2.5:1 |
| | black A | | black A | | |
| | | | first carbon | 1 | |
| | | | nanotubes | | |
| Example 10 | first carbon | 30 | second carbon | 10 | 2.5:1 |
| | black A | | black A | | |
| | | | first carbon | 1 | |
| | | | nanotubes | | |
| Comparative | first carbon | 20 | / | / | / |
| Example 1 | black A | | | | |
| Comparative | first carbon | 30 | / | / | / |
| Example 2 | black A | | | | |
| Comparative | first carbon | 40 | / | / | / |
| Example 3 | black A | | | | |
| Comparative | first carbon | 20 | second carbon | 10 | 2.5:1 |
| Example 4 | black A | | black A | | |
| Comparative | first carbon | 20 | second carbon | 15 | 2.5:1 |
| Example 5 | black A | | black A | | |
| Comparative | first carbon | 30 | second carbon | 10 | 2.5:1 |
| Example 6 | black A | | black A | | |
| Comparative | first carbon | 30 | second carbon | 15 | 2.5:1 |
| Example 7 | black A | | black A | | |
| Comparative | first carbon | 20 | second carbon | 10 | 2.5:1 |
| Example 8 | black A | | black A | | |
| | first | 10 | first carbon | 1 | |
| | activated | | nanotubes | | |
| | carbon | | | | |
| Comparative | first carbon | 30 | Second activated | 10 | 2.5:1 |
| Example 9 | black A | | carbon | | |
| | | | first carbon | 1 | |
| | | | nanotubes | | |
| Comparative | first | 30 | Second activated | 10 | 2.5:1 |
| Example 10 | activated | | carbon | | |
| | carbon | | carbon nanofibers | 1 | |
| Comparative | first carbon | 30 | second carbon | 10 | 2.5:1 |
| Example 11 | black A | | black A | | |
| | | | carbon nanofibers | 1 | |
| Comparative | first carbon | 40 | second carbon | 10 | 2.5:1 |
| Example 12 | black A | | black A | | |
| | | | first carbon | 1 | |
| | | | nanotubes | | |
| Comparative | first carbon | 30 | second carbon | 19 | 2.5:1 |
| Example 13 | black A | | black A | | |
| | | | first carbon | 1 | |
| | | | nanotubes | | |
| Comparative | first carbon | 30 | second carbon | 12 | 2.5:1 |
| Example 14 | black A | | black A | | |
| | | | first carbon | 8 | |
| | | | nanotubes | | |
| Comparative | first carbon | 30 | second carbon | 20 | 2.5:1 |
| Example 15 | black A | | black A | | |
| | | | first carbon | 4 | |
| | | | nanotubes | | |
| Comparative | first carbon | 30 | second carbon | 10 | 2.5:1 |
| Example 16 | black A | | black A | | |
| | | | first carbon | 1 | |
| | | | nanotubes | | |
| Comparative | first carbon | 30 | second carbon | 10 | 10:1 |
| Example 17 | black B | | black B | | |
| | | | first carbon | 1 | |
| | | | nanotubes | | |
| Comparative | second | 30 | second carbon | 10 | 1:1 |
| Example 18 | carbon | | black A | | |
| | black A | | first carbon | 1 | |
| | | | nanotubes | | |
| Comparative | first carbon | 30 | second carbon | 10 | 6.7:1 |
| Example 19 | black D | | black A | | |
| | | | first carbon | 1 | |
| | | | nanotubes | | |
| Comparative | first carbon | 30 | second carbon | 10 | 2:1 |
| Example 20 | black C | | black B | | |
| | | | first carbon | 1 | |
| | | | nanotubes | | |

### Performance Testing

Volume Resistivity Test: The test was conducted in accordance with the national standard T/CEEIA 610 2022, using a DC power source with an output voltage of 4.5 V. The brass rod electrode had a mass of 2 kg and a diameter of 40 mm, while the dimensions of the brass plate electrode were no less than 100 mm×100 mm×10 mm. A multimeter set to the Ω range was used. The dimensions of the insulating rubber mat were 300 mm×300 mm. The test temperature was 25° C.

Elongation at Break Test: The test was conducted in accordance with the national standard T/CEEIA 610 2022. The dimensions of the test samples were 5 cm×11 cm. The tensile speed was 500 mm/min, and the test temperature was 25° C.

The specific performance test results are presented in Table 2.

TABLE 2
Performance test results of conductive rubber composite
materials obtained from Examples and Comparative Examples

| | Volume resistivity | Elongation |
|---|---|---|
| Group | (Ω · cm) | at break (%) |
| Example 1 | 20 | 678 |
| Example 2 | 30 | 650 |
| Example 3 | 26 | 644 |
| Example 4 | 22 | 664 |
| Example 5 | 40 | 620 |
| Example 6 | 35 | 657 |
| Example 7 | 39 | 666 |
| Example 8 | 42 | 642 |
| Example 9 | 42 | 633 |
| Example 10 | 22 | 698 |
| Comparative Example 1 | 88 | 689 |
| Comparative Example 2 | 54 | 654 |
| Comparative Example 3 | 39 | 610 |
| Comparative Example 4 | 78 | 702 |
| Comparative Example 5 | 73 | 699 |
| Comparative Example 6 | 48 | 666 |
| Comparative Example 7 | 44 | 663 |
| Comparative Example 8 | 82 | 678 |
| Comparative Example 9 | 117 | 578 |
| Comparative Example 10 | 114 | 599 |
| Comparative Example 11 | 100 | 670 |
| Comparative Example 12 | 50 | 520 |
| Comparative Example 13 | 80 | 679 |
| Comparative Example 14 | 35 | 530 |
| Comparative Example 15 | 38 | 510 |
| Comparative Example 16 | 68 | 633 |
| Comparative Example 17 | 16 | 588 |
| Comparative Example 18 | 25 | 567 |
| Comparative Example 19 | 78 | 602 |
| Comparative Example 20 | 86 | 589 |

As shown in Table 2, the conductive rubber composite materials provided by the present application exhibit both superior mechanical performance and higher electrical conductivity. The volume resistivity can be equal to or less than 42 Ω·cm, and the elongation at break can be equal to or greater than 620%, demonstrating excellent comprehensive performance.

It can be seen from the results from Examples 1, 4, and 5 in Table 2 that when the average particle size of the first carbon black is 2 to 4 times the average particle size of the second carbon black (Examples 1 and 4), the resulting conductive rubber composite material possesses more outstanding electrical conductivity and mechanical performance. However, when the average particle size difference between the first carbon black and the second carbon black is excessively large (Example 5), even though the second carbon black exhibits excellent surface activity and van der Waals forces, the interaction between the first and second carbon blacks is reduced, reducing the improvement effects on the performance of the conductive rubber substrate provided by the conductive layer.

According to the results from Examples 1, 7, and 8 in Table 2, the incorporation of different types of anti-aging agents and vulcanization accelerators into the conductive rubber substrate can further enhance the comprehensive performance of the resulting conductive rubber composite material through the synergistic effects of the anti-aging agents and vulcanization accelerators.

Based on the results from Examples 1, 9, and 10, and Comparative Example 16 in Table 2, as the thickness of the conductive layer increases, the comprehensive performance of the resulting conductive rubber composite material initially improves and then declines. When the thickness of the conductive layer is increased to 0.5 mm (Comparative Example 16), the electrical conductivity and toughness are even substantially the same as those of Comparative Examples 1 and 2, which lack a conductive layer. This is because in an excessively thick conductive layer, the second carbon black and carbon nanotubes located farther from the conductive rubber substrate can hardly interact molecularly with the first carbon black in the substrate, leading to a decline in the comprehensive performance of the composite material.

According to Comparative Examples 1 to 3, without introducing a conductive layer, the electrical conductivity of the rubber is enhanced by solely increasing the amount of conductive filler (i.e., the first carbon black) in the conductive rubber substrate, leading to a decline in the mechanical performance of the rubber. This is due to excessive conductive filler being prone to aggregation, which forms stress concentration points under external forces, triggering rubber fracture and reducing its tensile strength and toughness.

According to Comparative Examples 4 to 7, when the conductive filler in the conductive layer consists only of zero-dimensional spherical carbon black without one-dimensional linear carbon nanotubes, the probability of forming conductive pathways between the carbon black particles decreases, resulting in reduced electrical conductivity of the conductive rubber composite material.

According to Comparative Examples 8 to 11, replacing carbon nanotubes with carbon nanofibers of similar morphology or replacing carbon black with activated carbon of similar morphology and same particle size fails to achieve the superior comprehensive performance of the present application. This is likely due to the better compatibility between carbon black and carbon nanotubes.

According to Comparative Examples 12 to 15, excessive addition of carbon black in the conductive rubber substrate or improper ratios and amounts of conductive fillers in the conductive layer leads to reduced interaction between the conductive rubber substrate and the conductive layer, thereby affecting the comprehensive performance of the resulting conductive rubber composite material.

According to Comparative Examples 17 to 20, even when the particle sizes of the first carbon black in the conductive rubber substrate and the second carbon black in the conductive layer are within the required ranges, a mismatch in particle size ratio between the first and second carbon blacks in the conductive rubber substrate and the conductive layer will prevent the achievement of the expected effects of the present application. In addition, even when the particle size ratio between the first and second carbon blacks is within the required range of the present application, the particle sizes of the first and second carbon blacks not in the required ranges will also prevent the achievement of the expected effects of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application.

1. A conductive rubber composite material, comprising a conductive rubber substrate and a conductive layer coated on a surface of the conductive rubber substrate;
wherein the conductive rubber substrate comprises following raw materials in parts by mass: 100 parts of a rubber material and 20 to 30 parts of first carbon black, wherein an average particle size of the first carbon black is in a range from 30 nm to 150 nm;
wherein the conductive layer comprises following raw materials in parts by mass: 100 parts of a coating base material, 8 to 15 parts of second carbon black, and 1 to 5 parts of carbon nanotubes, wherein the average particle size of the first carbon black is 1.2 to 8 times an average particle size of the second carbon black; and
wherein a thickness of the conductive layer is in a range from 0.05 mm to 0.2 mm.

2. The conductive rubber composite material according to claim 1, wherein the average particle size of the first carbon black in the conductive rubber substrate is in a range from 60 nm to 100 nm.

3. The conductive rubber composite material according to claim 1, wherein the carbon nanotubes in the conductive layer have a length in a range from 5 nm to 50 nm and a length-to-diameter ratio in a range from 100 to 1000.

4. The conductive rubber composite material according to claim 2, wherein the average particle size of the second carbon black in the conductive layer is in a range from 20 nm to 50 nm.

5. The conductive rubber composite material according to claim 1, wherein a mass ratio of the second carbon black to the first carbon black is in a range from 1:2 to 1:4.

6. The conductive rubber composite material according to claim 1, wherein the conductive rubber substrate further comprises at least one of an anti-aging agent, a vulcanization accelerator, or a vulcanizing agent.

7. The conductive rubber composite material according to claim 1, wherein the conductive layer further comprises a dispersant.

8. The conductive rubber composite material according to claim 1, wherein a thickness of the conductive layer is in range from 0.8 mm to 1.2 mm.

9. The conductive rubber composite material according to claim 1, wherein the average particle size of the first carbon black is 2 to 4 times the average particle size of the second carbon black.

10. The conductive rubber composite material according to claim 6, satisfying at least one of (a) to (e):
(a) the rubber material comprises butyl rubber;
(b) the anti-aging agent comprises N-cyclohexyl-N′-phenyl-p-phenylenediamine, paraffin, or a combination of N-cyclohexyl-N′-phenyl-p-phenylenediamine and paraffin;
(c) the vulcanization accelerator comprises stearic acid, zinc oxide, or a combination of stearic acid and zinc oxide;
(d) the coating base material comprises acrylic acid emulsion or polyacrylic acid; and
(e) the dispersant comprises a non-ionic surfactant.

11. The conductive rubber composite material according to claim 10, satisfying at least one of (f) to (i):
(f) in the raw materials of the conductive rubber substrate, the anti-aging agent is in an amount of 5 to 10 parts by mass;
(g) in the raw materials of the conductive rubber substrate, the vulcanization accelerator is in an amount of 5 to 8 parts by mass;
(h) in the raw materials of the conductive rubber substrate, the vulcanizing agent is in an amount of 1 to 3 parts by mass; and
(i) in the raw materials of the conductive layer, the dispersant is in an amount of 1 to 2 parts by mass.

12. The conductive rubber composite material according to claim 11, satisfying at least one of (j) to (l):
(j) a mass ratio of N-cyclohexyl-N′-phenyl-p-phenylenediamine to paraffin in the anti-aging agent is (2 to 4):(4 to 8);
(k) a mass ratio of stearic acid to zinc oxide in the vulcanization accelerator is (1 to 2):(5 to 7); and
(l) the non-ionic surfactant comprises fatty alcohol polyoxyethylene ether.

13. The conductive rubber composite material according to claim 6, wherein the vulcanizing agent is sulfur, 1,4-benzoquinone dioxime, or a combination of sulfur and 1,4-benzoquinone dioxime.

14. The conductive rubber composite material according to claim 10, wherein the acrylic acid emulsion comprises acrylic acid and a solvent, wherein a mass ratio of the acrylic acid to the solvent is 1:3.

15. A method for preparing the conductive rubber composite material according to claim 1, comprising following steps:
S1, uniformly mixing the raw materials of the conductive rubber substrate in parts by mass, kneading and vulcanizing at a temperature of 60° C. to 100° C., and molding at a temperature of 150° C. to 200° C. under a pressure of 10 MPa to 20 MPa to obtain the conductive rubber substrate; and
S2, uniformly mixing the raw materials of the conductive layer in parts by mass to obtain a conductive layer slurry, and coating the conductive layer slurry onto a surface of the conductive rubber substrate obtained in step S1, drying, thereby achieving the conductive rubber composite material.

16. A sealing member or an electromagnetic shielding member, comprising the conductive rubber composite material according to claim 1.
